(19) United States
(12) Patent Application Publication
(10) Pub. No.: US 2012/0004033 A1
(43) Pub. Date: Jan. 5, 2012

(54) DEVICE AND METHOD FOR REPLICATING A USER INTERFACE AT A DISPLAY

(76) Inventor: MARTIN LYONS, Las Vegas, NV (US)

(21) Appl. No.: 12/826,969

(22) Filed: Jun. 30, 2010

(51) Int. Cl. A63F 13/00; G06F 3/041; A63F 13/06; G06F 3/048

(52) U.S. Cl. 463/35; 715/772; 715/768; 715/702; 463/36

(57) ABSTRACT

The present invention relates to the placement of a reference replication of a device input apparatus at a display to confirm to a user the desired input. In the gaming field the present invention includes the generation of a semi-transparent image of the gaming machine button panel at the game display and an indicia showing the player's input to confirm the desired prompt.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates to systems, apparatus and methods related to display devices used in connection with user interface devices. More particularly the present invention relates to devices which include a display and an interface device such as a separate button panel or touch input device such as a touch screen display button panel. Still more particularly the present invention relates to gaming devices which include a display and an interface device such as a separate button panel or touch input device such as a touch screen display button panel.

### BACKGROUND OF THE INVENTION

Apparatus which include a video display and player interface device are known. A personal computer with a monitor and keyboard are a good example. The monitor presents content to the user and the user interfaces with the computer processor via the keyboard. Typically the monitor has a screen which is arranged at least somewhat orthogonal to the view of the user and the keyboard is positioned horizontally below the display to accommodate the user's hands and fingers. Given the standard layout of the keyboard keys and the haptic feel from the physical, mechanical keyboard buttons the user has feedback to avoid invalid or undesired inputs. For word processing functions the display of the letters input at the keyboard also provide a visual feedback to the user.

In the field of gaming it has been known to provide a gaming device (commonly referred to as a slot machine) which includes a video main display as well as a separate electro-mechanical button panel for a player to input selections. Typically the main display is oriented vertically or somewhat slanted to be at least somewhat orthogonal to the view of the player. The button panel is typically arranged substantially horizontally apart from but below the main display in a position for the player to actuate the buttons with their fingers. It has also been known to provide the main display as a touch screen display including active displayed buttons for a user to touch to generate input. For example, Heidel, U.S. Pat. No. 5,342,047 (the disclosure of which is incorporated by reference) discloses a gaming device having both electro-mechanical buttons separate from the main touch screen display as well as touch screen buttons replicated at the main display so the player may use either sets of buttons. Again the fixed layout of buttons and their haptic feedback provides a reference for the player to confirm a proper or desired input.

It has been proposed to replace the electro-mechanical buttons with a virtual button deck configured as a touch screen display separate from the main display of the gaming machine. A controller controls the virtual button deck to display the action buttons which, if touched by the player, provide control input into the gaming device such as registering wagers, cashing out, selecting bet amounts and prompting play (a “spin”) of the game. For a virtual button deck players may have a more difficult time becoming accustomed to the positioning of the displayed action buttons and occasionally may touch and activate (or attempt to activate) an invalid or undesired input prompt. Of course the player can look at the button panel but that diverts the player's attention from the main display content. Further the constant looking up and down between the main game display and button deck can become annoying and tiresome. These drawbacks become accentuated where the device or gaming device virtual button panel is subject to change such as by changing the game to be played. For example, the gaming device may be capable of presenting different games to the player. One game may be a video Poker game having buttons to control the holding and discarding of cards as well as other functions such as the wager amount. Another game may be a spinning reel game having buttons to select pay arrangements, wagers and the like. To accommodate the functions of the spinning reel game the touch screen virtual button panel may change or the active buttons of an electro-mechanical button panel may be different. Downloadable gaming where different games are downloaded to a gaming terminal to provide multiple games at the terminal is known. Service based gaming presenting different games and where the bulk of the processing takes place at a gaming server is also known. For both downloadable and server based gaming the gaming content and active button arrangements may change. A change in the active buttons or orientation of buttons for the button panel relative to the game may cause the player to make improper or undesired input prompts by touching or depressing the incorrect buttons. The player, for a touch screen display button panel, may touch in an area which does not even correspond to a button.

The same issues exist with other devices such as personal computer monitors and keyboards. Keyboards are available which are broadcast or are embodied as thin, flexible panels. An example of a broadcast, virtual keyboard is the Celluon Laser Key CL850 Projection Keyboad from Celluon, Inc. of Seoul, South Korea. An example of a flexible panel keyboard is a roll-up keyboard manufactured/distributed by Unotron of Dallas, Tex. These types of input devices may not provide relative feel of electro-mechanical buttons like a standard keyboard for a user to determine the orientation of the hands/fingers without looking at the keyboard to get a visual reference.

It would be advantageous to provide a visual reference key for the user of an interface device at the main display or monitor of the orientation of their finger(s) or inputs without the user having to look at the interface device and without disturbing the display of content at the main display. For applications such as using a virtual or thin panel keyboard, there is a need for an unobtrusive, head up display at the main display or monitor of a visual key to confirm proper input and/or orientation of the finger(s) to effectuate proper input. For gaming devices there is a need to provide an unobtrusive display at the main game display of one or more visual feedback keys to confirm and effectuate the desired game input. This is particularly true where the active buttons or the display of buttons at a touch screen display button panel change such as with downloadable or server based gaming. There is particularly a need for a visual reference which does not obstruct or detract from the presentation of the content at the display.

### SUMMARY OF THE INVENTION

There is set forth a device operable through a user interface which includes a device main display. The main display may be a computer monitor or the video display for a gaming machine. Where the gaming machine is of the type having electro-mechanical reels the main display may be a window for viewing the reels with a supplemental or overlying video display. The device includes a controller configured to display content at the video display. Where the device is a computer the controller may be the processor and graphics rendering software. Where the device is, for example, a gaming device the controller is the gaming machine processor and graphics rendering software. A user interface disposed separate from the main display is provided for a user to input selections. The interface may be a keyboard or button panel. The controller and/or interface is configured to display an inactive, replication of at least a portion of the user interface at the main display to provide to the user a head up reference to re-enforce a valid input or provide a visual key regarding a invalid input. In one embodiment the replication is displayed in a portion of the main display. In another embodiment the replication is displayed as a semi-transparent replication of at least a portion of the interface seemingly over the displayed content. For example, for a valid input, the replication may be a semi-transparent view of the interface button/key depressed by the user confirming that the user has touched the desired input button or key. Where the user has touched an incorrect or invalid button or key the controller may control the display to display a replication of the invalid button or key (or touch position) in reference to valid or nearby buttons or keys or in reference to the entire button panel. Displayed indicia indicating the position of the user's touch or input may give the user a reference so they can alter their finger position to make the desired input.

In another aspect of the present invention there is provided a device having a main display and a user interface separate from the main display such as a virtual button deck, laser keyboard or thin panel keyboard of the type where the input buttons cannot be easily ascertained by feel. A controller is provided which control the display to display content. Where the device is a gaming device the content may be the symbols for a slot machine or a window through which the player views electro-mechanical stepper reels. The controller is configured to display an inactive replication of at least a portion of the user interface at the main display to provide to the user a “head up” reference display to re-enforce a valid input or provide a visual reference regarding a invalid input, e.g. relationship between the user's touch or button actuation and a valid or proper input. For example, where the device is a gaming device and the user interface is a virtual button deck comprising a touch screen display, where the player has touched at a location which does not correspond to a button, the controller controls the main display to display an opaque or semi-transparent replication of at least a portion of the panel to inform the player of an invalid prompt and to provide a visual reference to show where the player's touch is relative to the buttons.

In a further embodiment the controller may be configured to display with the semi-transparent replication of at least a portion of the interface, an indicia corresponding to the relative position of the user/player's touch or input. For example the indicia may be a semi-transparent image of a hand and finger, pointer or the like. In the fashion, without looking at the interface the player knows where their touch is relative to at least one input button.

In still a further embodiment, the controller and/or input device may be configured to permit the player to touch the input device and slide to find the desired input. Once the touch is at the desired input, the user/player can lift their finger resulting in the desired input prompt.

The controller and/or interface may be configured to define a “home” or “safe” position on the interface. If a user/player is unsure about where they are touching they can touch the “safe” position which is replicated as a semi-transparent image of at least a portion of the input device and an indicia showing the location of the touch and the player can slide their finger to “find” the desired prompt by viewing the replication at the main display. The prompt can be entered by one of the player lifting their finger. Where the interface is a pressure sensitive touch screen device the user/player an prompt an input by pressing down with a heavy touch on the “found” button to signal the desired input.

Multi-touch technology can also be used. For example the interface and/or controller may be configured such that a player touch with one finger activates the generation of the semi-transparent replication of at least a portion of the interface and a second finger could be moved, represented by an indicia displayed at the main display, to “find” the desired input.

For still a further embodiment the controller and/or display may be configured to provide different haptic effects depending upon whether the finger is touching an input button. The controller may be configured to include sound feedback to the user/player to provide further reference feedback.

For still a further embodiment the controller may be configured to position the main display to accommodate a fully visible, opaque, replication according to the embodiments described above. For example the main display content may be compressed to accommodate the replication at the bottom of the main display

### BRIEF DESCRIPTION OF THE DRAWINGS

These and other features of the present invention will become appreciated as the same becomes better understood with reference to the description, claims and drawings wherein:

FIG. 1 illustrates a computer device for inclusion of the aspects of the present invention;

FIG. 2 illustrates a gaming device according to one aspect of the present invention;

FIG. 3 is a perspective view of a virtual button deck including a touch screen display;

FIG. 4 is a view of an example of a button layout at the virtual button deck of FIG. 3;

FIGS. 5a-b is a diagram of a gaming device controller and system interface;

FIG. 6 is a block diagram of the logical components of a gaming kernel in accordance with one or more embodiments;

FIG. 7 illustrates one embodiment of the present invention

FIGS. 8a and b represent a schematic block diagram showing the hardware elements of a networked gaming system in accordance with one or more embodiments;

FIGS. 9A and 9B illustrate a gaming video display and virtual button panel interface;

FIGS. 10a and 10B illustrate the display of a semi-transparent replication of at least a portion of the interface over the content at the main display;

FIG. 11 is a logic diagram for an embodiment of the present invention;

FIG. 12 is a logic diagram for an embodiment of the present invention; and

FIG. 13 is a logic diagram for an embodiment of the present invention.

### DESCRIPTION

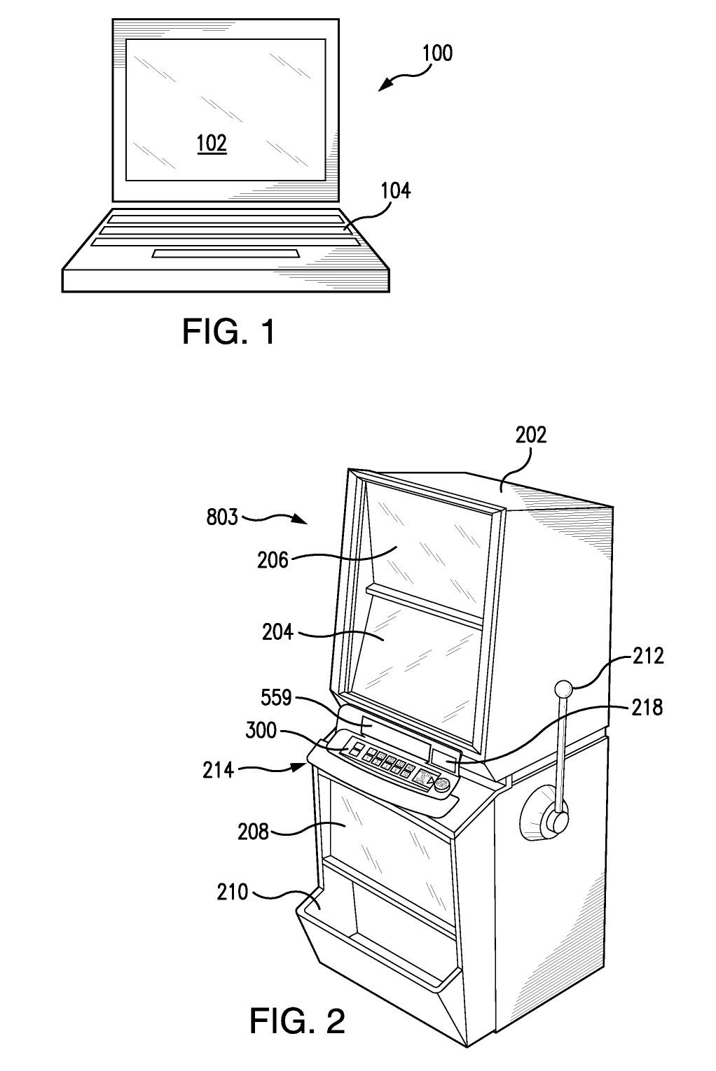

Referring to the drawings, FIG. 1 shows a computer device 100 of the type having a main display 102 and a user interface 104 shown as a keyboard. The main display 102 may be a video display such as a plasma display, LCD, OLED or other type of video display provided to display video content to a user. The keyboard 104 may be an electro-mechanical button keyboard as is known in the art or it may be a thin film display with touch buttons or a virtual keyboard such as a laser, broadcast keyboard of the type referenced above or a touch screen display interface. The interface 104 is separate from the main display 102. In the usual orientation the main display 102 is positioned in front of the user and somewhat orthogonal to the direction of view so the content on the main display 102 can be viewed. The interface 104 is positioned substantially horizontally so that the buttons can be manipulated by the user.

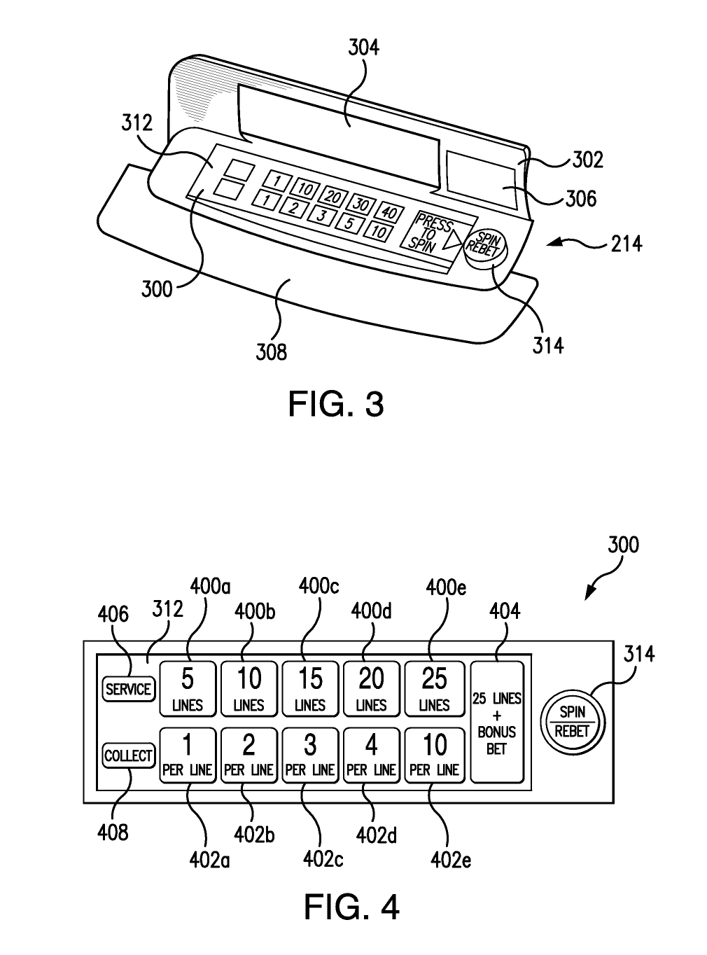

While the present invention may be applied to the computer device 100 described above, turning to FIG. 2 a specific application of the present invention is shown. In this embodiment a gaming device or machine 803 is shown. The gaming device 803 may be a video Poker gaming device, a video reel slot machine game, a game having electro-mechanical stepper reels, a video lottery game, Keno game or any other gaming device. Further the gaming device 803 may be a terminal configured to interface with a remote server (not shown) to receive game content (game graphics and operating instructions) to provide for the play of numerous different games through an enterprise gaming system as hereinafter described. The gaming device 803 may also be a terminal configured to interface with a server (not shown) to provide server based gaming. Downloadable and server based gaming is known in the art. Unless otherwise indicated, the description related to this embodiment shall presume the game is a video reel slot machine gaming device.

The gaming device 803 includes a cabinet 202 providing an enclosure for the contents thereof. The cabinet 202 mounts a main display 204 which may be any suitable video display such as plasma, LCD, OLED or other electronic, video display. The main display 204 may also constitute a window for viewing a plurality of electro-mechanical stepper reels where the gaming device is a stepper game. Again stepper reel games are well known in the art. A main video display may be provided above, below or over the stepper reels as is also known in the art. The main display 204 as shown in FIG. 1 is positioned substantially somewhat vertically to be somewhat orthogonal to the view of the player so the player can view content displayed thereon. Where the gaming device 803 is a “slant” slot machine the main display 204 is positioned to be in front of the player at an angle as is well known in the art. The main display 204 may be tilted to some degree to deflect glare. Above the main display 204 the gaming device 803 may include a secondary video display 206. The secondary display 206 may be an electronic video display or stepper reel display as described in reference to the main display 204 or it may be backlit, printed glass or plastic providing, for example, game graphics, game pay schedules or the like, again as is known in the art. Below the main display 204 is a belly glass 208 which is typically backlit printed glass or plastic displaying, for example, the game name and related graphics. A coin tray 210 may be provided; however in most modern applications the gaming device 803 uses cash currency/printed tickets/value cards to receive value for gaming and dispense value to the player. To accommodate receiving and dispensing value the gaming device 803 would include (not shown), for example and is known in the art, a cash accepter to receive, read and validate cash scrip and printed tickets/coupons and a ticket dispenser to print a value ticket voucher when the player desires to cash out his/her winnings. Young et al US Application 2009/0275394 A1 and titled “Game Transaction Module Interface to Single Port Printer”, the disclosure of which is incorporated by reference herein, discloses a gaming device having a cash accepter and ticket dispenser. A handle 212 may be provided for the player to prompt play of the gaming device 803.

With reference to FIGS. 2-4 the gaming device 803 includes a player interface 214 disposed below the main display 204. The interface 214 includes a button panel 300 oriented somewhat horizontally to accommodate the player's hands and fingers. Disposed adjacent to the button panel 300 is a flange 302 including a first and a second opening 304, 306. The first opening 304 is configured to surround and support a player tracking display 559 and the second opening 306 is configured to surround and support the head of a player card reader 218. Opposite the flange 302 is a padded rest 308 for the player to rest their hands and wrists.

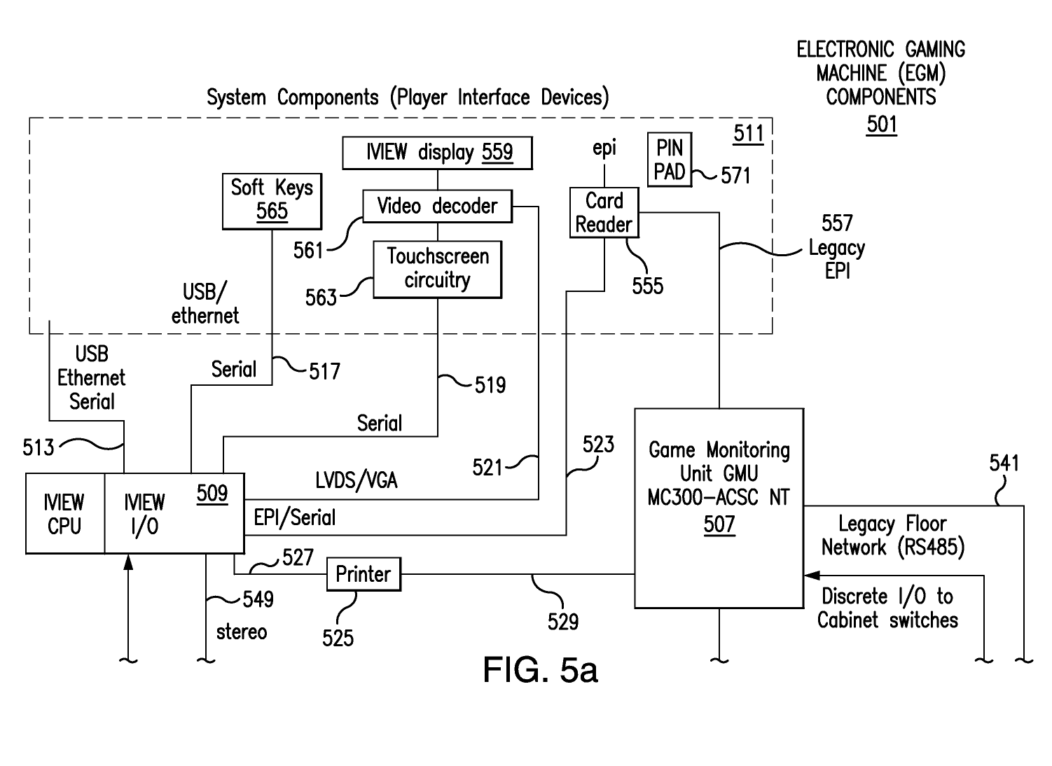

The interface 214 may include a button panel 300 of electro-mechanical buttons as is known in the art and described in Young et al US Application 2009/0275394 A1 and titled Game Transaction Module Interface to Single Port Printer” which has been incorporated by reference herein. The button panel 300 may also be a flexible panel keyboard such as a roll-up keyboard manufactured/distributed by Unotron of Dallas, Tex. In a preferred embodiment the button panel 300, or at least a portion thereof, is embodied as a touch screen display 312. The touch screen display 312 may display all of the necessary input buttons for the player or, in the alternative as shown in FIG. 3, a separate electro-mechanical SPIN/REBET button 314 is provided. It should be appreciated that the SPIN/REBET button 314 could be displayed at the touch screen display 312 with the other buttons hereinafter described.

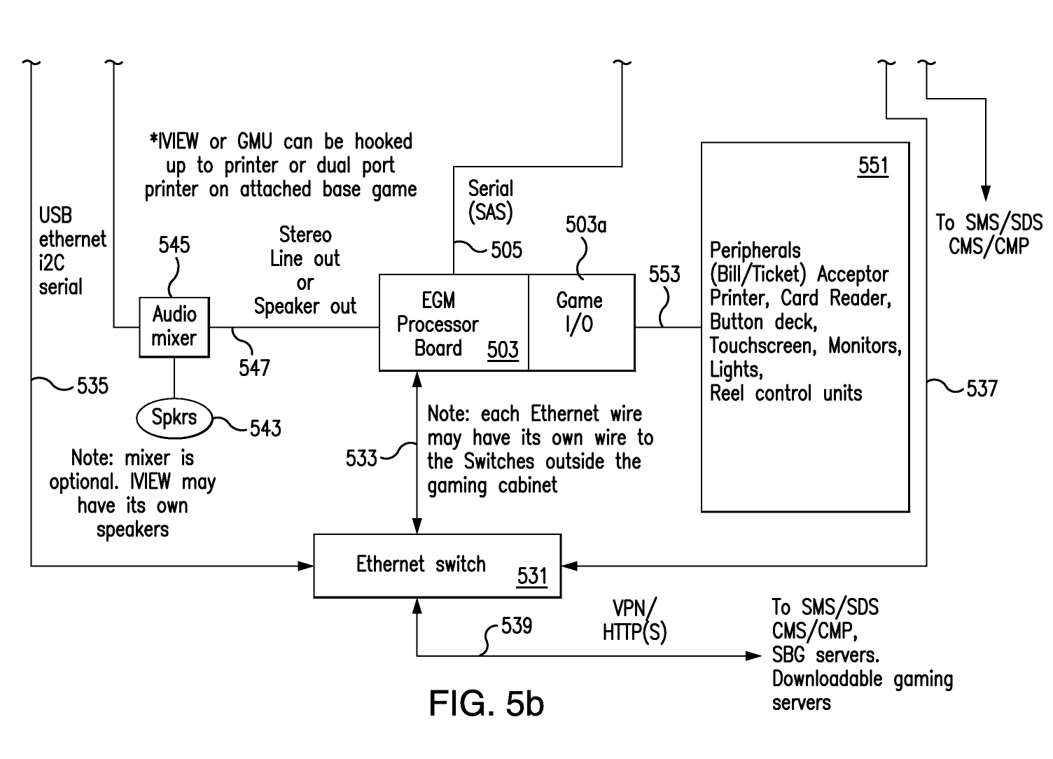

The touch screen display 312 includes a plurality of buttons displayed under control of one or both of the interface 214 or gaming device controller described below. FIG. 4 shows an example of the touch buttons for the interface 214. It should be appreciated that, depending upon the game offered by the gaming device 803 the number and arrangement of buttons could well change from that shown. Therefore the following description should not be interpreted as limiting the invention to the button arrangement described. The displayed buttons include a row of line selection buttons 400a-e to enable, when touched by the player, to select respectively 5-Lines, 10-Lines, 15-Lines, 20-Lines and 25-Lines upon which to wager. As is known in the art and relative to a video reel game and described below, the game will on any “spin” randomly present symbols in a matrix such as a 3 (row)×5 (column) matrix, 3×3 matrix or other configuration. Various pay lines can be cast though the matrix including one symbol from each column and the player is invited to wager upon one or more of these pay lines. Crouch, U.S. Pat. No. 5,580,053 titled “Multi-line Gaming Device”, the disclosure of which is incorporated by reference, discloses pay line arrangements for wagering for a 3×5 matrix game. Below the line selection buttons 400a-e, is a number of wager buttons 402a-e for the player to select the amount to wager for each selected pay line corresponding to wagers of 1-unit, 2-units, 3-units, 5-units and 10-units. A unit wager is a unit of currency for example 1-cent. In the exemplary touch screen display 312 of FIG. 4 there is also displayed a “25-Line+Bonus Bet button 404 which, if touched by the player automatically enables 25 pay lines plus lodges a bonus bet to, for example, enable a special feature of the game. This special feature may be to access the chance to win bonus free games, enter a bonus feature game, and enable multipliers or the like.

Other touch screen buttons such as a service button 406 which, if touched, initiates a signal to call an attendant and a collect button 408 which if touched prompts the gaming machine to cash out the credits accumulated during play, as is known in the art.

The touch screen display 312 may be any touch sensitive input device such as resistive, surface acoustic wave, capacitive (including surface capacitance and projected capacitance), force panel technology or optical imaging as are known in the art.

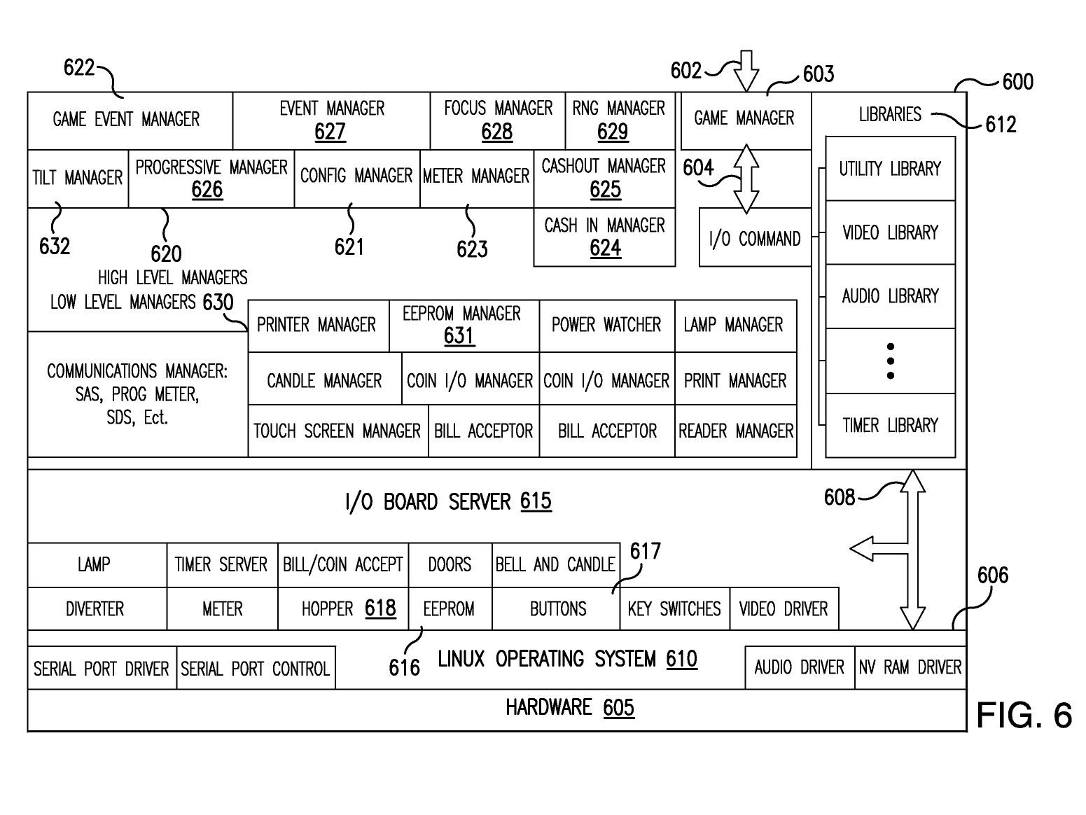

Referring to FIGS. 5a-b, electronic gaming machine 803 hardware 501 is shown in accordance with one or more embodiments. The hardware 501 includes base game integrated circuit board 503 (EGM Processor Board) connected through serial bus line 505 to game monitoring unit (GMU) 507 (such as a Bally MC300 or ACSC NT), and player interface integrated circuit board (PIB) 509 connected to player system interface devices 511 over bus lines 513, 515, 517, 519, 521, 523. Gaming voucher ticket printer 525 (for printing player cash out tickets) is connected to PIB 509 and GMU 507 over bus lines 527, 529. EGM Processor Board 503, PIB 509, and GMU 507 connect to Ethernet switch 531 over bus lines 533, 535, 537. Ethernet switch 531 connects to a slot management system (SMS) and a casino management system (CMS) network over bus line 539. Ethernet switch 531 may also connect to a server based gaming server or a downloadable gaming server. GMU 507 also may connect to the SMS and CMS network over bus line 541. Speakers 543 to produce sounds related to the game or according to the present invention connect through audio mixer 545 and bus lines 547, 549 to EGM Processor Board 503 and PIB 509.

Peripherals 551 connect through bus 553 to EGM Processor Board 503. The peripherals 551 include, but are not limited to the following and may include individual processing capability: bill/ticket acceptor to validate and accept currency and ticket vouchers, player loyalty card reader, the button panel 300 including the touch screen display 312, main display 204 touch screen, monitors, lights, and where the gaming device 200 is a stepper reel game, stepper reel control units. For example, a bill/ticket acceptor is typically connected to a game input-output board 503a which is, in turn, connected to a conventional central processing unit (“CPU”) board 503, such as an Intel Pentium microprocessor mounted on a gaming motherboard. I/O board 503a may be connected to CPU processor board 503 by a serial connection such as RS-232 or USB or may be attached to the processor by a bus such as, but not limited to, an ISA bus. The gaming motherboard may be mounted with other conventional components, such as are found on conventional personal computer motherboards, and loaded with a game program which may include a gaming machine operating system (OS), such as a Bally Alpha OS. Processor board 503 executes a game program that causes processor board 503 to play a game. The various components and included devices may be installed with conventionally and/or commercially available components, devices, and circuitry into a conventional and/or commercially available gaming machine cabinet, an example of which is described above.

When a player has inserted a form of currency such as, for example and without limitation, paper currency, coins or tokens, cashless tickets or vouchers, electronic funds transfers or the like into the currency acceptor, a signal is sent by way of I/O board 553 to processor board 503 which, in turn, assigns an appropriate number of credits for play in accordance with the game program. The player may further control the operation of the gaming machine by way of other peripherals 551, for example, to select the amount to wager via electromechanical or touch screen buttons. The game starts in response to the player operating a start mechanism such as a handle, button such as the SPIN/RESET button 314 or touch screen icon. The game program includes a random number generator to provide a display of randomly selected indicia on one or more displays such as the main display 204. In some embodiments, the random generator may be physically separate from gaming machine 200; for example, it may be part of a central determination host system which provides random game outcomes to the game program. Thereafter, the player may or may not interact with the game through electromechanical or touch screen buttons to change the displayed indicia. Finally, processor board 503 under control of the game program and OS compares the final display of indicia to a pay table. The set of possible game outcomes may include a subset of outcomes related to the triggering of a feature game. In the event the displayed outcome is a member of this subset, processor board 503, under control of the game program and by way of I/O Board 553, may cause feature game play to be presented on a feature display.

Predetermined payout amounts for certain outcomes, including feature game outcomes, are stored as part of the game program. Such payout amounts are, in response to instructions from processor board 503, provided to the player in the form of coins, credits or currency via I/O board 503a and a pay mechanism, which may be one or more of a credit meter, a coin hopper, a voucher printer, an electronic funds transfer protocol or any other payout means known or developed in the art.

In various embodiments, the game program is stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In one embodiment, the remote storage device is housed in a remote server such as a downloadable gaming server. The gaming machine may access the remote storage device via a network connection, including but not limited to, a local area network connection, a TCP/IP connection, a wireless connection, or any other means for operatively networking components together. Optionally, other data including graphics, sound files and other media data for use with the EGM are stored in the same or a separate memory device (not shown). Some or all of the game program and its associated data may be loaded from one memory device into another, for example, from flash memory to random access memory (RAM).

In one or more embodiments, peripherals may be connected to the system over Ethernet connections directly to the appropriate server or tied to the system controller inside the EGM using USB, serial or Ethernet connections. Each of the respective devices may have upgrades to their firmware utilizing these connections.

GMU 507 includes an integrated circuit board and GMU processor and memory including coding for network communications, such as the G2S (game-to-system) protocol from the Gaming Standards Association, Las Vegas, Nev., used for system communications over the network. As shown, GMU 507 may connect to a player card reader 555 through bus 557 and may thereby obtain player card information and transmit the information over the network through bus 541. Gaming activity information may be transferred by the EGM Processor Board 503 to GMU 507 where the information may be translated into a network protocol, such as S2S, for transmission to a server, such as a player tracking server, where information about a player's playing activity may be stored in a designated server database.

PID 509 includes an integrated circuit board, PID processor, and memory which includes an operating system, such as Windows CE, a player interface program which may be executable by the PID processor together with various input/output (I/O) drivers for respective devices which connect to PID 509, such as player interface devices 511, and which may further include various games or game components playable on PID 509 or playable on a connected network server and PID 509 is operable as the player interface. PID 509 connects to card reader 555 through bus 523, player tracking display 559 through video decoder 561 and bus 521, such as an LVDS or VGA bus.

As part of its programming, the PID processor executes coding to drive player tracking display 559 and provide messages and information to a player. Touch screen circuitry interactively connects display 559 and video decoder 561 to PID 509; such that a player may input information and cause the information to be transmitted to PID 509 either on the player's initiative or responsive to a query by PID 509. Additionally soft keys 565 connect through bus 517 to PID 509 and operate together with the player tracking display 559 to provide information or queries to a player and receive responses or queries from the player. PID 509, in turn, communicates over the CMS/SMS network through Ethernet switch 531 and busses 535, 539 and with respective servers, such as a player tracking server.

Player interface devices 511 are linked into the virtual private network of the system components in gaming machine 501. The system components include the iVIEW® processing board and game monitoring unit (GMU) processing board. The iVIEW® is a system interface device sold by assignee Bally Gaming, Inc. Of Las Vegas, Nev. which over a network to the slot management system and/or casino management system (such as a commercially available ACSC™, CSC™, CMP™, CMS/400™, MCC™ and SDS™ sold by Bally Gaming, Inc. Of Las Vegas, Nev.).

The GMU system component has a connection to the base game through a serial SAS connection and is connected to various servers using, for example, HTTPs over Ethernet. Through this connection, firmware, media, operating system software, gaming machine configurations can be downloaded to the system components from the servers. This data is authenticated prior to install on the system components.

The system components include the iVIEW® processing board and game monitoring unit (GMU) processing board. The GMU and iVIEW® can combined into one like the commercially available Bally GTM iVIEW device. This device may have a video mixing technology to mix the EGM processor's video signals with the iVIEW® display onto the top box monitor, player tracking display 559 or any monitor on the gaming device.

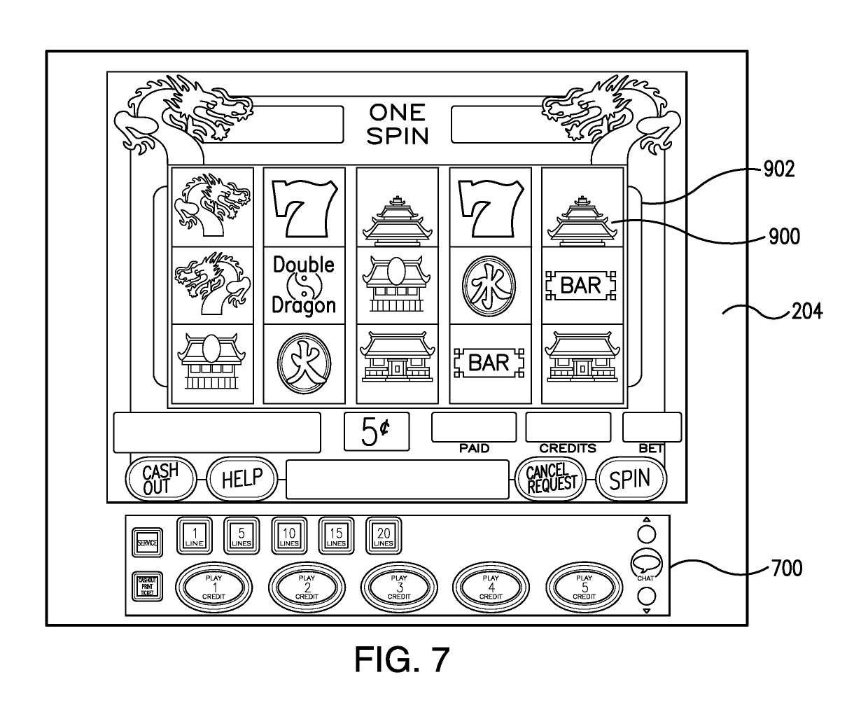

In accordance with one or more embodiments, FIG. 6 is a functional block diagram of a gaming kernel 600 of a game program under control of processor board 503. The game program uses gaming kernel 600 by calling into application programming interface (API) 602, which is part of game manager 603. The components of game kernel 600 as shown in FIG. 6 are only illustrative, and should not be considered limiting. For example, the number of managers may be changed, additional managers may be added or some managers may be removed without deviating from the scope and spirit of the invention.

As shown in the example, there are three layers: a hardware layer 605; an operating system layer 610, such as, but not limited to, Linux; and a game kernel layer 600 having game manager 603 therein. In one or more embodiments, the use of a standard operating system 610, such a UNIX-based or Windows-based operating system, allows game developers interfacing to the gaming kernel 600 to use any of a number of standard development tools and environments available for the operating systems. This is in contrast to the use of proprietary, low level interfaces which may require significant time and engineering investments for each game upgrade, hardware upgrade, or feature upgrade. The game kernel layer 600 executes at the user level of the operating system 610, and itself contains a major component called the I/O Board Server 615. To properly set the bounds of game application software (making integrity checking easier), all game applications interact with gaming kernel 600 using a single API 602 in game manager 603. This enables game applications to make use of a well-defined, consistent interface, as well as making access points to gaming kernel 600 controlled, where overall access is controlled using separate processes.

For example, game manager 603 parses an incoming command stream and, when a command dealing with I/O comes in (arrow 604), the command is sent to an applicable library routine 612. Library routine 612 decides what it needs from a device, and sends commands to I/O Board Server 615 (see arrow 608). A few specific drivers remain in operating system 610's kernel, shown as those below line 606. These are built-in, primitive, or privileged drivers that are (i) general (ii) kept to a minimum and (iii) are easier to leave than extract. In such cases, the low-level communications is handled within operating system 610 and the contents passed to library routines 612.

Thus, in a few cases library routines may interact with drivers inside operating system 610, which is why arrow 608 is shown as having three directions (between library utilities 612 and I/O Board Server 615, or between library utilities 612 and certain drivers in operating system 610). No matter which path is taken, the logic needed to work with each device is coded into modules in the user layer of the diagram. Operating system 610 is kept as simple, stripped down, and common across as many hardware platforms as possible. The library utilities and user-level drivers change as dictated by the game cabinet or game machine in which it will run. Thus, each game cabinet or game machine may have an industry standard processor board 503 connected to a unique, relatively dumb, and as inexpensive as possible I/O adapter board 540, plus a gaming kernel 600 which will have the game-machine-unique library routines and I/O Board Server 615 components needed to enable game applications to interact with the gaming machine cabinet. Note that these differences are invisible to the game application software with the exception of certain functional differences (i.e., if a gaming cabinet has stereo sound, the game application will be able make use of API 602 to use the capability over that of a cabinet having traditional monaural sound).

Game manager 603 provides an interface into game kernel 600, providing consistent, predictable, and backwards compatible calling methods, syntax, and capabilities by way of game application API 602. This enables the game developer to be free of dealing directly with the hardware, including the freedom to not have to deal with low-level drivers as well as the freedom to not have to program lower level managers 630, although lower level managers 630 may be accessible through game manager 603's interface 602 if a programmer has the need. In addition to the freedom derived from not having to deal with the hardware level drivers and the freedom of having consistent, callable, object-oriented interfaces to software managers of those components (drivers), game manager 603 provides access to a set of upper level managers 620 also having the advantages of consistent callable, object-oriented interfaces, and further providing the types and kinds of base functionality required in casino-type games. Game manager 603, providing all the advantages of its consistent and richly functional interface 602 as supported by the rest of game kernel 600, thus provides a game developer with a multitude of advantages.

Game manager 603 may have several objects within itself, including an initialization object (not shown). The initialization object performs the initialization of the entire game machine, including other objects, after game manager 603 has started its internal objects and servers in appropriate order. In order to carry out this function, the kernel's configuration manager 621 is among the first objects to be started; configuration manager 621 has data needed to initialize and correctly configure other objects or servers.

The upper level managers 620 of game kernel 600 may include game event log manager 622 which provides, at the least, a logging or logger base class, enabling other logging objects to be derived from this base object. The logger object is a generic logger; that is, it is not aware of the contents of logged messages and events. The log manager's (622) job is to log events in non-volatile event log space. The size of the space may be fixed, although the size of the logged event is typically not. When the event space or log space fills up, one embodiment will delete the oldest logged event (each logged event will have a time/date stamp, as well as other needed information such as length), providing space to record the new event. In this embodiment, the most recent events will thus be found in the log space, regardless of their relative importance. Further provided is the capability to read the stored logs for event review.

In accordance with one embodiment, meter manager 623 manages the various meters embodied in the game kernel 600. This includes the accounting information for the game machine and game play. There are hard meters (counters) and soft meters; the soft meters may be stored in non-volatile storage such as non-volatile battery-backed RAM to prevent loss. Further, a backup copy of the soft meters may be stored in a separate non-volatile storage such as EEPROM. In one embodiment, meter manager 623 receives its initialization data for the meters, during start-up, from configuration manager 621. While running, the cash in (624) and cash out (625) managers call the meter manager's (623) update functions to update the meters. Meter manager 623 will, on occasion, create backup copies of the soft meters by storing the soft meters' readings in EEPROM. This is accomplished by calling and using EEPROM manager 631.

In accordance with still other embodiments, progressive manager 626 manages progressive games playable from the game machine 200 (if any). Event manager 627 is generic, like log manager 622, and is used to manage various gaming machine events. Focus manager 628 correlates which process has control of various focus items. Tilt manager 632 is an object that receives a list of errors (if any) from configuration manager 621 at initialization, and during game play from processes, managers, drivers, etc. that may generate errors. Random number generator manager 629 is provided to allow easy programming access to a random number generator (RNG), as a RNG is required in virtually all casino-style (gambling) games. RNG manager 629 includes the capability of using multiple seeds.

In accordance with one or more embodiments, a credit manager object (not shown) manages the current state of credits (cash value or cash equivalent) in the game machine, including any available winnings, and further provides denomination conversion services. Cash out manager 625 has the responsibility of configuring and managing monetary output devices. During initialization, cash out manager 625, using data from configuration manager 621, sets the cash out devices correctly and selects any selectable cash out denominations. During play, a game application may post a cash out event through the event manager 627 (the same way all events are handled), and using a call-back posted by cash out manager 625, cash out manager 625 is informed of the event. Cash out manager 625 updates the credit object, updates its state in non-volatile memory, and sends an appropriate control message to the device manager that corresponds to the dispensing device. As the device dispenses dispensable media, there will typically be event messages being sent back and forth between the device and cash out manager 625 until the dispensing finishes, after which cash out manager 625, having updated the credit manager and any other game state (such as some associated with meter manager 623) that needs to be updated for this set of actions, sends a cash out completion event to event manager 627 and to the game application thereby. Cash in manager 624 functions similarly to cash out manager 625, only controlling, interfacing with, and taking care of actions associated with cashing in events, cash in devices, and associated meters and crediting.

In a further example, in accordance with one or more embodiments, I/O server 615 may write data to the gaming machine EEPROM memory, which is located in the gaming machine cabinet and holds meter storage that must be kept even in the event of power failure. Game manager 603 calls the I/O library functions to write data to the EEPROM. The I/O server 615 receives the request and starts a low priority EEPROM thread 616 within I/O server 615 to write the data. This thread uses a sequence of 8 bit command and data writes to the EEPROM device to write the appropriate data in the proper location within the device. Any errors detected will be sent as IPC messages to game manager 603. All of this processing is asynchronous.

In accordance with one embodiment, button module 617 within I/O server 615, polls (or is sent) the state of buttons every 2 ms. These inputs are debounced by keeping a history of input samples. Certain sequences of samples are required to detect a button was pressed, in which case the I/O server 615 sends an inter-process communication event to game manager 603 that a button was pressed or released. In some embodiments, the gaming machine may have intelligent distributed I/O which debounces the buttons, in which case button module 617 may be able to communicate with the remote intelligent button processor to get the button events and simply relay them to game manager 603 via IPC messages. In still another embodiment, the I/O library may be used for pay out requests from the game application. For example, hopper module 618 must start the hopper motor, constantly monitor the coin sensing lines of the hopper, debounce them, and send an IPC message to the game manager 603 when each coin is paid.

Further details, including disclosure of lower level fault handling and/or processing, are included in U.S. Pat. No. 7,351,151 entitled “Gaming Board Set and Gaming Kernel for Game Cabinets” and provisional U.S. patent application No. 60/313,743, entitled “Form Fitting Upgrade Board Set For Existing Game Cabinets,” filed Aug. 20, 2001; said patent and provisional are both fully incorporated herein by explicit reference.

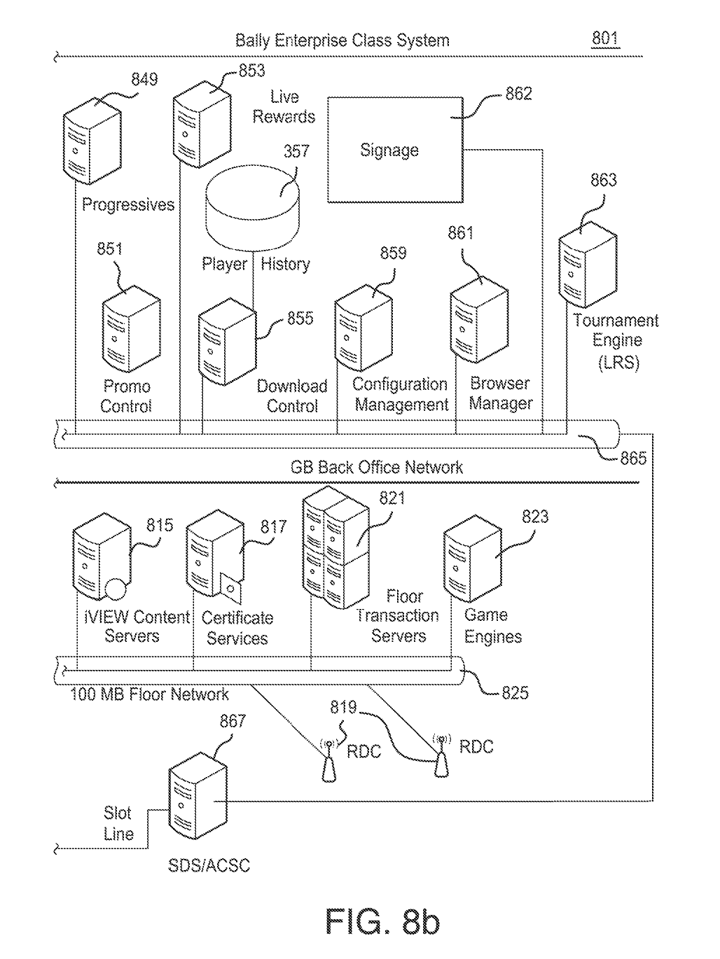

Referring to FIGS. 8a, b, an enterprise gaming system 801 is shown. The enterprise gaming system 801 represents a system for monitoring and controlling the various gaming devices 803 on one or more casino floors. Enterprise gaming system 801 may include one casino or multiple locations and generally includes a network of gaming devices 803, floor management system (SMS) 805, and casino management system (CMS) 807. SMS 805 may include load balancer 811, network services servers 813, player interface (iVIEW) content servers 815, certificate services server 817, floor radio dispatch receiver/transmitters (RDC) 819, floor transaction servers 821 and game engines 823, each of which may connect over network bus 825 to gaming machines 803. CMS 807 may include location tracking server 831, WRG RTCEM server 833, data warehouse server 835, player tracking server 837, biometric server 839, analysis services server 841, third party interface server 843, slot accounting server 845, floor accounting server 847, progressives server 849, promo control server 851, bonus game (such as Bally Live Rewards) server 853, download control server 855, player history database 857, configuration management server 859, browser manager 861, tournament engine server 863 connecting through bus 865 to server host 867 and gaming machines 803. The various servers and gaming machines 803 may connect to the network with various conventional network connections (such as, for example, USB, serial, parallel, RS485, Ethernet). Additional servers which may be incorporated with CMS 807 include a responsible gaming limit server (not shown), advertisement server (not shown), and a control station server (not shown) where an operator or authorized personnel may select options and input new programming to adjust each of the respective servers and gaming devices 803. SMS 805 may also have additional servers including a control station (not shown) through which authorized personnel may select options, modify programming, and obtain reports of the connected servers and devices, and obtain reports. The various CMS and SMS servers are descriptively entitled to reflect the functional executable programming stored thereon and the nature of databases maintained and utilized in performing their respective functions.

Gaming devices 803 include various peripheral components that may be connected with USB, serial, parallel, RS-485 or Ethernet devices/architectures to the system components within the respective gaming machine. The GMU 507 has a connection to the base game through a serial SAS connection. The system components in the gaming cabinet may be connected to the servers using HTTPs or G2S over Ethernet. Using CMS 807 and/or SMS 305 servers and devices, firmware, media, operating systems, and configurations may be downloaded to the system components of respective gaming machines for upgrading or managing floor content and offerings in accordance with operator selections or automatically depending upon CMS 807 and SMS 805 master programming. The data and programming updates to gaming devices 803 are authenticated using conventional techniques prior to install on the system components.

In various embodiments, any of the gaming devices 803 may be a mechanical reel spinning slot machine, video slot machine, video poker machine, keno machine, video blackjack machine, or a gaming machine offering one or more of the above described games including a group play game. Alternately, gaming devices 803 may provide a game with collapsing reels as one of a set of multiple primary games selected for play by a random number generator, as described above. A gaming system of the type described above also allows a plurality of games in accordance with the various embodiments of the invention to be linked under the control of a group game server (not shown) for cooperative or competitive play in a particular area, carousel, casino or between casinos located in geographically separate areas. For example, one or more examples of group games under control of a group game server are disclosed in U.S. application Ser. No. 11/938,079, entitled “Networked System and Method for Group Play Gaming,” filed on Nov. 9, 2007, which is hereby incorporated by reference in its entirety for all purposes.

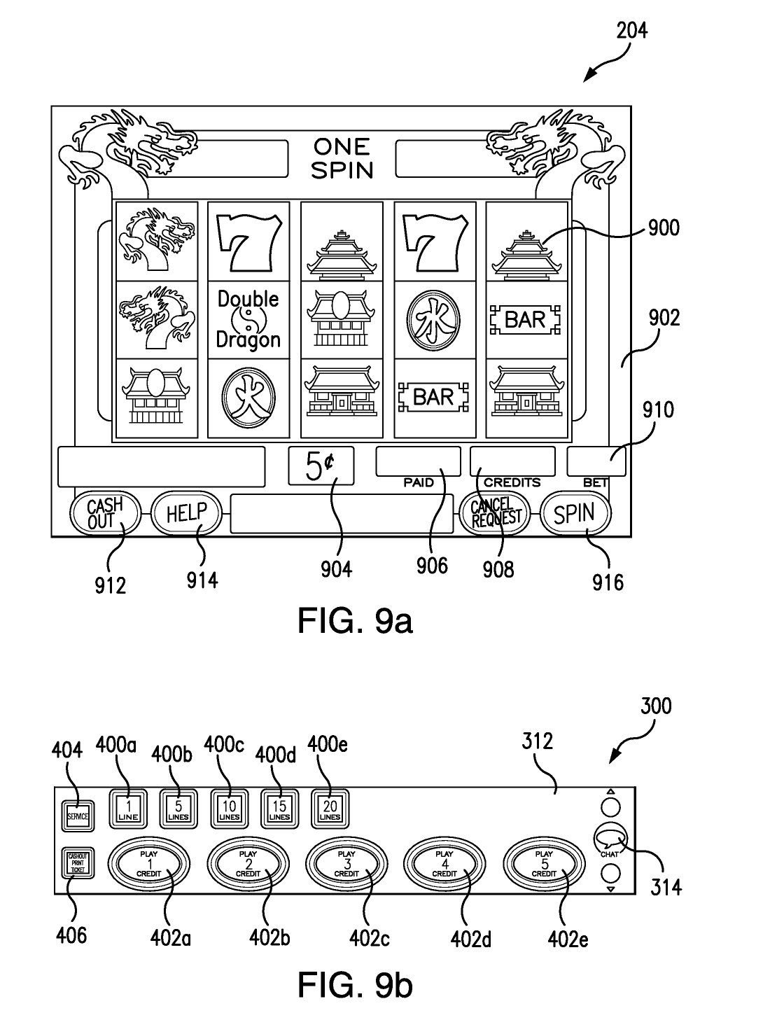

Turning to FIGS. 9a and 9b there is shown an example of displayed content at the main display 204 in the form of a game outcome and a button panel 300, in this instance a touch screen display 312. In this example the content displayed includes the 3×5 game matrix 900 of game symbols. A border 902 is displayed surrounding the matrix 900 which includes some complementary game graphics (a pair of dragons) as well as some functional elements as hereinafter described. As disclosed above, the main display 204 would display the matrix 900 and border 902 in front of a player usually substantially orthogonal to the player's direction of view or at an angle where the gaming machine is a slant top gaming device. The button panel 300 is provided, as shown in FIG. 2, apart from the main display 204 (usually below the main display 204) and in a somewhat horizontal orientation to accommodate the player's hands and fingers. For example, FIG. 2 shows the positions of the button panel 300 spaced from and below the main display 204.

Disposed at the bottom of the border 902 is a denomination banner 904 informing the player that each unit wagered is equivalent to 5¢. Adjacent to the denomination banner 904 is a graphic window to display a paid meter 906, credits meter 908 and a bet meter 910. As is known in the art the paid meter 906 displays to the player the amount paid (won) as a result of a spin or play of the game, the credits meter 908 displays the credits the player has available for wagering and the bet meter 910 displays the total amount wagered by the player for any spin/play of the game.

In the current example of FIGS. 9a, 9b, the main display 204 is a touch screen display. A number of touch screen buttons are displayed at the main display 204, some duplicative of the buttons on the touch screen display 312 of the button panel 300. These displayed buttons are “active” meaning that the player may touch them to input a prompt. There is provided cash out button 912 which if touched by the player will result in the player cashing out the credits registered at the credits meter 908. A help button 914 will prompt the controller 501 to control the main display 204 (and/or secondary display 206) to display help information to the player such as game rules, the pay schedule, pay line arrangements and the like. A spin button 916, if touched, prompts the control 501 to process and control the main display 204 to display a game outcome and test the outcome of any winning symbol combinations. If any winning symbol combinations are found, they are paid and the payments are displayed at the paid meter 906 and summed at the credits meter 908. Depending upon the rules of the game buttons may be temporarily inactivated. For example, after the player has made a wager but before the spin of the reels, the player would typically not be permitted to cash out requiring the disablement of any collect/cash out button 408, 912.

The button panel 300 includes displayed line buttons 400a-e and wager buttons 402a-e. Additionally there is displayed another spin button 314 (duplicative of the one displayed at the touch screen main display 204), a service button 404 and a collect button 406 (the function is duplicative of the cash out button 912).

To play a spin of the game the player registers credits with the game by, for example, inserting cash or a ticket voucher into the bill acceptor 551. Using the button panel 300 the player selects their wagering options for example touching line button 400e to enable twenty pay lines and wager button 402e to wager five units (5×5¢) on each pay line for a total wager of 20×$0.25=$5.00. The total bet is displayed at the bet meter 910. Touching either spin button 314, 916 the controller 501 is prompted to select and display an outcome of symbols in the game matrix 900 and to test for winning outcomes.

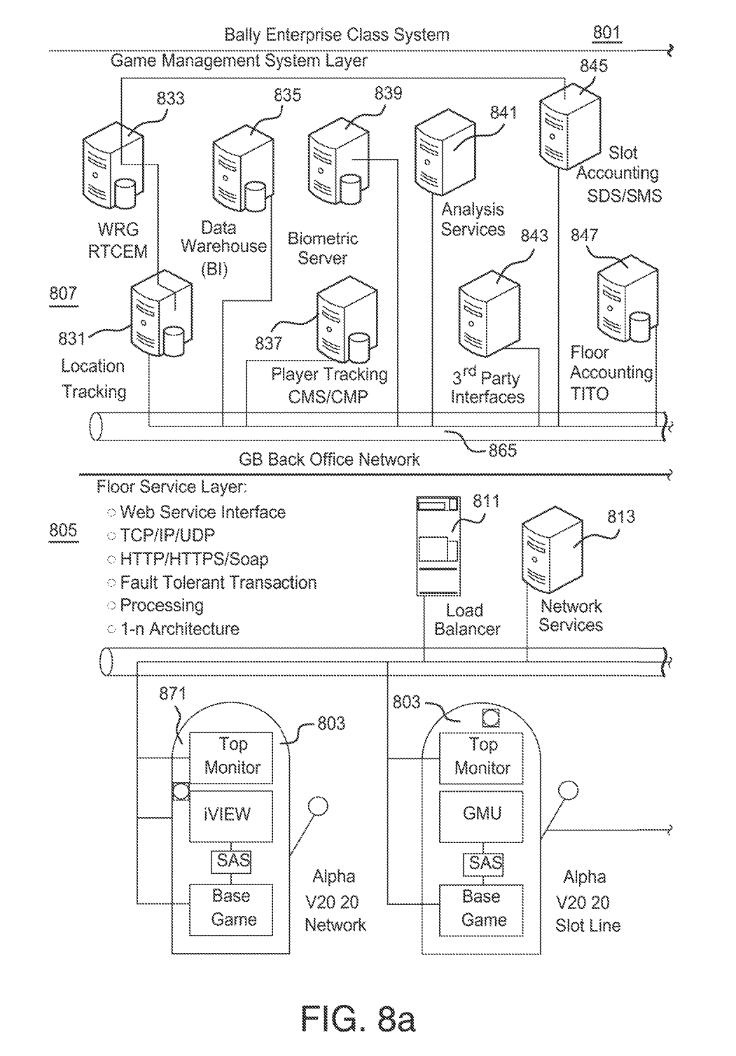

Turning to FIG. 7 an embodiment of the present invention is shown. To provide a visual, “head up”, key regarding the user's/player's input at the button panel 300, the controller 501 is configured to control the main display 204 to modify the display of the content (game matrix 900 and border 902) to a smaller area or “window” in the display 204 to accommodate an inactive, opaque, replication 700 of the button panel 300 at the main display 204. Inasmuch as the button panel 300 includes the touch screen display 312 the player may not have the haptical feedback (i.e. feel) they would have with traditional electro-mechanical buttons. The touch screen display 312 is smooth so there is no feedback through feel to confirm touch with a valid or desired key. By referencing the inactive replication 700 of the button panel 300 at the main display 204 the player can confirm the orientation and layout of the buttons without the need to glance down at the button panel 300. By an “inactive” replication 700 what is meant is a replication of at least a portion of the button panel 300 and where the replicated button(s) are non-functional. The purpose for the replication 700 is to provide the player with a reference layout. In connection with this display, the controller 501 may be configured to highlight or light a button in the replication 700 for the player to confirm the desired button or input has been entered.

The reconfiguration of the main display 204 to depict the replication 700 may occur in the event the player has touched an invalid or improper entry (“touch”) such as by touching the interface 214 at an improper button or for a touch screen display 312 in a location not associated with a button or with a deactivated button. For example, if the player has not completed their wager options and presses the spin button 616, the controller 501 would interpret that as an invalid prompt and would call up a routine to shrink the game matrix 900 and border 902 and display the replication 700. The display of the replication 700 would help inform the player of an improper or invalid input. The player may then move their finger over the touch screen displayed button panel to highlight buttons in the replication 700 until the desired button is found. The player may then either lift their finger or press down to enter the desired input.

A player may be able to call up or disable the replication 700 by entering a suitable prompt such as by prompting the help button 914 and selecting an enabling or disabling function. The replication 700 may only be called up when the player has made a predetermined number of invalid prompts over a period of time indicating unfamiliarity with the button panel 300. The replication 700 may also be called up when there is a change to the button panel 300 such as during a bonus game or when a new game is going to be played.

The replication 700 does not deactivate any of the touch screen buttons for the main display 204 or on the button panel 300.

The replication 700 need not be displayed below the game matrix 900. It could be displayed above or to one side of the game matrix 900. Optionally, the player/user may select where they desire the replication 700 to appear.

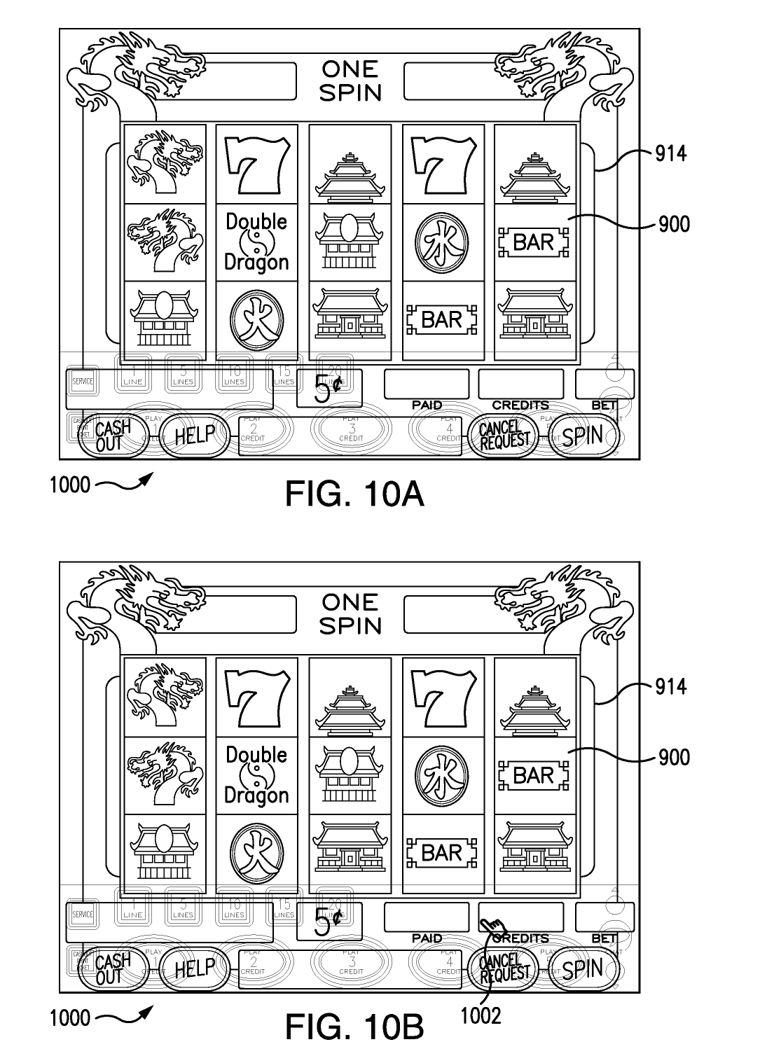

Turning to FIGS. 10a and 10b in a preferred embodiment, the controller 501 and/or button panel 300 is/are configured to display the replication 700 as an inactive, semi-transparent replication 1000 of at least a portion of the button panel over the content of the main display 204. The controller 501 controls the main display 204 to display the replication 1000 over a portion of the border 902 for example below the game matrix 900. Depending upon the color scheme for the content the replication 1000 may be positioned elsewhere over the displayed content. The color of the replication 1000 may be altered to make the replication 1000 more visible (but still semi-transparent). By semi-transparent what is meant is that the replication 1000 appears as a ghost image over the content and the underlying content is still visible to the player.

As described above, the controller 501 may be configured to continuously display the inactive, semi-transparent replication 1000 over the content or its display may be triggered by events such as an invalid input or prompt, a touch on the touch screen display 312 not associated with a button or a sequence of event such as a number of invalid inputs by the player. The player/user may disable or enable the replication 1000 as desired as well.

With reference to FIG. 10b the controller 501 may also be configured to display a semi-transparent indicia 1002 shown as a hand which corresponds to the user's/player's input or prompt. If a player touches or presses a button the controller 501 is configured to display the indicia 1002 interacting with the button in the replication 900. If the player touches for example a location on the touch screen display 312 which is not associated with a button, the controller 501 and/or button panel 300 is/are configured to display the indicia 1002 in the replication 1000 at the position in the button panel 300 corresponding to the position of the touch. In this fashion, by the player viewing the replication they can move their touch to the desired button. The controller 501 may be configured to apply the indicia 1002 on the opaque replication of FIG. 7 as well.

With the indicia 1002 the player can touch a button panel 300 touch screen display 312 at an invalid or “safe” location such as the upper right hand corner of the touch screen display 312, view the replication 1000 and indicia 1002 at the main display 204 over the content and move their finger over the display 312 followed by the replicated movement of the indicia 1002 to a desired button and either lift their finger to generate the input or where the touch screen display 312 is pressure sensitive such as the type developed by Peratech, Ltd., of North Yorkshire, UK), press down at the button to enter the input. As the player moves their finger buttons in the replication 1000 may be highlighted such as by expanding or becoming more opaque or changing color to provide feedback to the player of the relative position of their finger. The displayed pointer indicia 1002 may be semi-transparent or, because it is relatively small, may be displayed as opaque.

The replication 1000 may highlight a valid touch such as enlarging the touched button, flashing the button, momentarily showing the button as opaque or the like.

Where the touch screen display 312 is a multi-touch screen, a plurality of indicia 1002, one of each touch point, can be displayed by the controller 501 at the replication 1000.

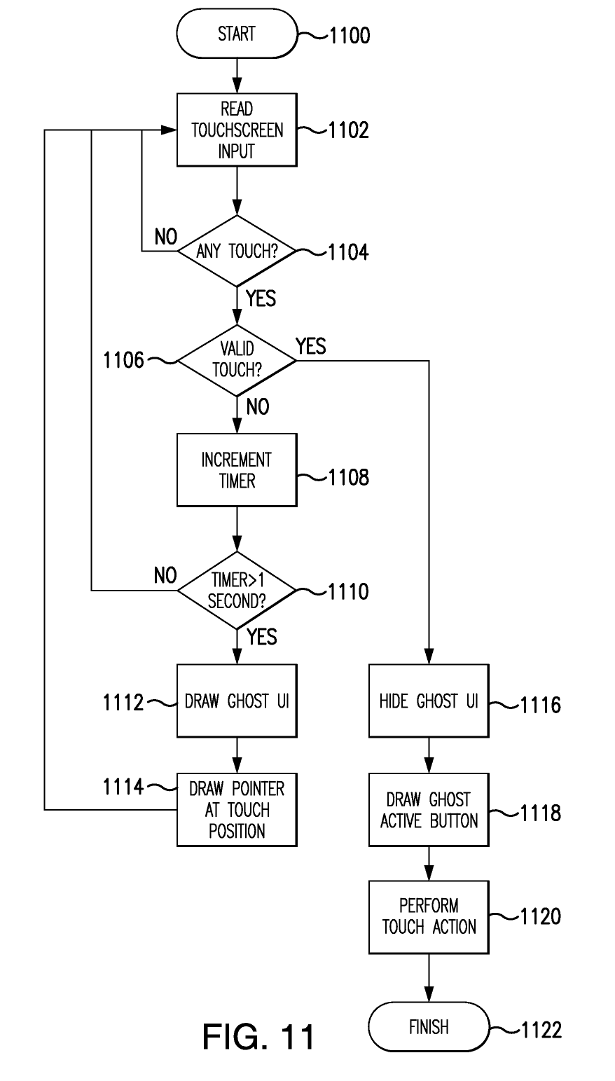

FIG. 11 shows a logic diagram for one embodiment of the present invention. At the start 1100 the controller 501 and/or button panel 300 are placed in an operative condition, i.e. powered and booted up and at 1102 the button touch screen display 312 is read by the controller 501. At 1104 the controller 501, again alone or in combination with any button panel 300 microprocessor, determines if there has been any touch at the touch screen display 312. The touch at the touch screen display 312 is tested at 1106 to determine if there has been a valid touch, i.e. the player has touched an active button to interface with the game. If the touch is invalid, e.g. not on an active button, at 1108 a timer is initiated and begins to increment to a trigger, for example a period of 1 or 2 seconds. When the timer has timed out at 1110, the controller 510/button panel 312 at 1112 draws the replication 700 or according to another embodiment the semi-transparent, ghost replication 1000 at the main display 204 over the displayed content and at 1114 draws the pointer indicia 1002 to corresponding the touch position of the player's finger. The player can adjust their touch position, as mimicked by the pointer indicia 1002 position at the replication 700 or 1000, to adjust their touch position to the desired button. The controller 501/button panel 300 at 1102 reads the touch screen position until, at 1106, a valid touch input is registered. When a valid touch is sensed, at 1106 the controller 510/button panel 300 hides the replication 700 or 1000 save for at 1118 drawing or highlighting a button of replication 700 or the semi-transparent, ghost image of the touched button to reinforce the visual feedback of the correct touch position. At 1120 the touch input is recognized at the touch screen display 312 interface. The transaction is finished at 1122.

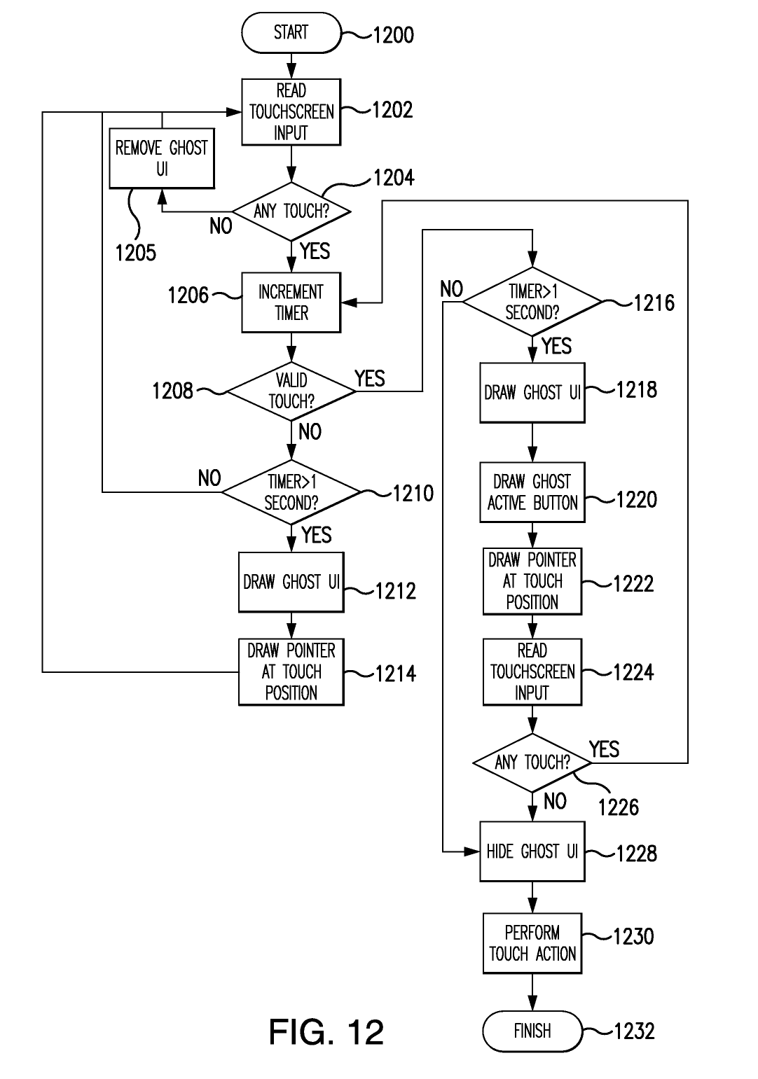

FIG. 12 is a logic diagram showing an embodiment of the present invention where the player can slide their touch to the desired input prompt. At 1200 the controller 501, button panel 300 and gaming machine 803 are placed in an operative condition and at 1202 the button touch screen display 312 is read by the controller 501. At 1204 the controller 501, again alone or in combination with a button panel 300 microprocessor (if any), determines if there has been a first touch at the touch screen display 312. If no touch is detected at 1205 any drawn semi-transparent, inoperative ghost replication 1000 of the buttons or opaque replication 700 displayed at the main display 204 is removed. If a touch is detected at 1206 a timer is initiated and at 1208 a determination is made as to whether the touch is a valid touch input (whether a valid input or not). If a determination is made that the touch is invalid at 1208 (not at an active button) and at 1210 the timer has expired, at 1212 the controller 501 controls the main display 204 to draw or display the replication 700 or 1000 and at 1214 the pointer indicia 902 at the location of the touch relative to the buttons. If at 1208 it is determined that the touch is valid (at a valid input button), when the time expires at 1216 at 1218 the controller 501 controls the main display 204 to draw the replication 700 or, according to another embodiment, the semi-transparent, inactive interface replication 1000 including at 1220 displaying the active button touched and at 1222 controlling the display to display the indicia 1002 at the button. At 1224 the controller 501 (and/or button panel 300 microprocessor, if any) reads the touch screen for any additional touch. If at 1126 an additional touch (valid or invalid) the logic is returned to initiation of the timer at 1206 as shown. If there is no second touch sensed at 1226 or if the timer at 1216 has expired without an additional touch, at 1228 the replication 700/1000 is removed from the display and at 1230 the touch input(s) are acted upon. At 1232 the procedure is finished.

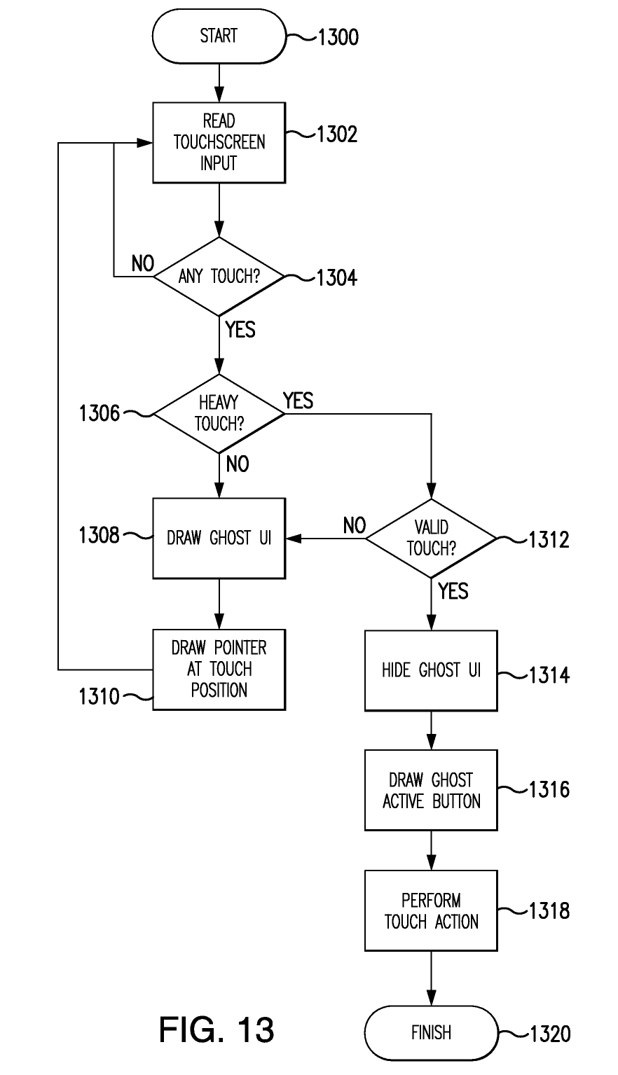

Turning now to FIG. 13 there is shown a logic diagram for an embodiment including a pressure sensitive touch screen button panel 300. At 1300 the controller 501, button panel 300 and gaming machine 803 are placed in an operative condition and at 1302 the button touch screen display 312 is read by the controller 501. If at 1304 a touch is detected the controller 504 (and/or a microprocessor for the button panel 300) at 1306 a determination is made whether the touch is a “heavy” touch sufficient to register an input. If the touch is too light at 1308 the controller 501 controls the display, e.g. display 900, to show the replication 700/1000 and at 1310 show the indicia 1002 to indicate the position of the player's touch. The player can then slide their touch to the desired button and at 1306 register a heavy touch. When the heavy touch is registered at 1306 it is recognized at 1312 which prompts the controller 504 to remove the display of the replication 700/1000 from the display at 1314 and display a replication of the touched button at 1316. Finally at 1318 the button input is performed and at 1320 the procedure is finished.

One of ordinary skill in the art will appreciate that not all gaming machines have all these components and may have other components in addition to, or in lieu of, those components mentioned here. Furthermore, while these components are viewed and described separately, various components may be integrated into a single unit in some embodiments.

The preferred embodiment described above is provided by way of illustration only and should not be construed to limit the claimed invention. Those skilled in the art will readily recognize that the claimed invention can be practiced in a substantially equivalent way with various modifications and changes that may be made to the claimed invention without following the example embodiments and applications illustrated and described herein, and without departing from the true spirit and scope of the claimed invention, which is set forth in the following claims.

What is claimed:

1. A device operable through a user interface comprising:
a device main display;
a controller configured to display content at said main display;
a user interface for a user to input selections and disposed separate from said main display;
said controller configured to display an inactive replication of at least a portion of said interface at said main display.

2. The device of claim 1 comprising said controller configured to display said replication of at least a portion of said interface when an invalid input selection is made by the user.

3. The device of claim 2 comprising said controller configured to fade in the replication over time.

4. The gaming device of claim 1 comprising said controller configured to control the main display to display a reference indicia in said main display corresponding to the position of the user's input at said interface.

5. The device of claim 1 comprising said user interface is a keyboard.

6. The device of claim 5 comprising said user interface is a virtual keyboard.

7. The device of claim 6 comprising said controller configured to display said replication of at least a portion of said keyboard when an invalid input selection is made by the user.

8. The device of claim 1 comprising said controller configured to control the main display to display a reference indicia corresponding to the position of the user's input.

9. The device of claim 8 comprising said user interface includes at least one touch input button, said controller configured to display said reference indicia at said main display corresponding to the position touched by the user as the user moves the touched position at said touch display device.

10. The device of claim 1 comprising one of said controller and interface configured to control the main display to confine the display of content to a first portion of the main display and display said replication at a second portion of the main display.

11. The device of claim 10 comprising one of said controller and interface configured to display a reference indicia corresponding to the position of the user's input in said second portion.

12. The device of claim 1 comprising said controller is configured to control the display to display an inactive, semi-transparent replication of at least a portion of said interface at said main display over at least a portion of said content.

13. The device of claim 12 comprising said controller configured to display said replication of at least a portion of said interface when an invalid input selection is made by the user.

14. The device of claim 12 comprising said controller is configured to fade in the replication over time.

15. The device of claim 12 comprising said controller configured to control the main display to display a reference indicia in said main display corresponding to the position of the user's input at said interface.

16. The device of claim 12 comprising said user interface is a keyboard.

17. The device of claim 16 comprising said user interface is a virtual keyboard.

18. The device of claim 17 comprising said controller configured to display said replication of at least a portion of said keyboard when an invalid input selection is made by the user.

19. The device of claim 12 comprising said controller configured to control the main display to display a reference indicia corresponding to the position of the user's input.

20. The device of claim 19 comprising said user interface includes at least one touch input button, said controller configured to display said reference indicia at said main display corresponding to the position touched by the user as the user moves the touched position at said touch display device.

21. The device of claim 12 comprising one of said controller and interface configured to provide a haptical feedback relative to the position of at least one input button.

22. The device of claim 12 comprising one of said controller and interface configured to provide an auditory feedback corresponding to the touch position of the user relative to at least one input button.

23. The device of claim 1 one of said controller and interface configured to provide a haptical feedback relative to the position of at least one input button.

24. The device of claim 1 comprising one of said controller and interface configured to provide an auditory feedback corresponding to the touch position of the user relative to at least one input button.

25. A gaming device for play by a player comprising:
a main display;
a controller configured to display game content at said main display;
a button panel disposed separate from said main display and including at least one button for a user to input selections and;
said controller configured to display an inoperative replication of at least a portion of said button panel at said main display.

23. The gaming device of claim 25 comprising said controller configured to display said replication of at least a portion of said button panel when an invalid input selection is made by the user.

24. The gaming device of claim 25 comprising said controller is configured to fade in the replication over time.

25. The gaming device of claim 25 comprising said controller configured to control the main display to display a reference indicia in said main display corresponding to the position of said player's input at said button panel.

26. The gaming device of claim 25 button panel is a virtual button panel.

27. The gaming device of claim 26 comprising virtual button panel is a touch screen display having at least one input button displayed thereat.

28. The gaming device of claim 25 comprising said controller configured to display said replication of at least a portion of said button panel when an invalid input selection is made by the player.

29. The gaming device of claim 25 comprising said controller is configured to control the main display to display a reference indicia corresponding to the position of the player's input.

30. The device of claim 25 comprising said button panel includes a touch screen display having at least one touch input button, said controller configured to display said reference indicia at said main display corresponding to the position touched by the player as the player moves the touched position at said touch display.

31. The device of claim 25 comprising said controller is configured to control the display to display an inactive, semi-transparent replication of at least a portion of said button panel at said main display over said content.

32. The device of claim 25 comprising said controller configured to display said replication of at least a portion of said interface when an invalid input selection is made by the user.

34. The device of claim 25 comprising said controller is configured to fade in the replication over time.

35. The gaming device of claim 25 comprising said controller configured to control the main display to display a reference indicia in said main display corresponding to the position of the user's input at said interface.

36. The device of claim 25 comprising said user interface is a keyboard.

37. The device of claim 36 comprising said user interface is a virtual keyboard.

38. The device of claim 37 comprising said controller is configured to display said replication of at least a portion of said keyboard when an invalid input selection is made by the user.

39. The device of claim 25 comprising said controller configured to control the main display to display a reference indicia corresponding to the position of the user's input.

40. The device of claim 39 comprising said user interface includes at least one touch input button, said controller configured to display said reference indicia at said main display corresponding to the position touched by the user as the user moves the touched position at said touch display device.

41. The device of claim 25 comprising one of said controller and interface configured to provide a haptical feedback relative to the position of at least one input button.

42. The device of claim 25 comprising one of said controller and interface configured to provide an auditory feedback corresponding to the touch position of the user relative to at least one input button.

43. The device of claim 31 one of said controller and interface configured to provide a feedback haptic relative to the position of at least one input button.

44. The device of claim 31 comprising one of said controller and interface configured to provide an auditory feedback corresponding to the touch position of the user relative to at least one input button.

45. A device operable through a user interface comprising:
a device main display;
a controller configured to display content at said main display;
a user interface for a user to input selections and disposed separate from said main display;
said controller configured to display an inactive, semi-transparent replication of at least a portion of said interface at said main display over said content.

46. The device of claim 45 comprising said user interface is a button panel.

47. The device of claim 45 comprising said user interface is a touch screen display displaying at least one interface button.

48. The device of claim 47 comprising one of said controller and interface including at least one of a haptical or auditory feedback corresponding to the touch position of the user at the interface.

49. The device of claim 47 comprising one of said controller and interface configured to display at said main display an indica corresponding to the position of the user's touch.

50. A gaming device operable through a user interface comprising:
a device main display;
a controller configured to display content at said main display;
a user interface for a user to input selections and disposed separate from said main display;
said controller configured to display an inactive, semi-transparent replication of at least a portion of said interface at said main display over said content.

51. The gaming device of claim 50 comprising said user interface is a button panel.

52. The device of claim 50 comprising said user interface is a touch screen display displaying at least one interface button.

53. The device of claim 52 comprising one of said controller and interface including at least one of a haptical or auditory feedback corresponding to the touch position of the user at the interface.

54. The device of claim 52 comprising one of said controller and interface configured to display at said main display an indicia corresponding to the position of the user's touch.

55. A method for providing at a main display a reference display related to a user's input at a user interface displayed apart from said main display comprising:
controlling the content displayed at the display with a controller;
a user interfacing with the controller by using buttons at said interface;
displaying an inoperable replication of at least a portion of said interface at said display to provide visual feedback to the user regarding the use of the interface.

56. The method of claim 55 comprising displaying at said display an indicia representative of the position of the player's input at said interface.

56. The method of claim 55 comprising displaying an inoperative, semi-transparent of at least a portion of said interface over said content.

57. The method of claim 55 comprising providing a touch screen display displaying at least one input button as said user interface.

58. The method of claim 57 comprising displaying an indicia representative of the position of the player's touch screen input at said interface.

56. A method for providing at a main display for a gaming device a reference related to the player's input at a separate button panel comprising:
controlling the main display to display content including game content;
the player interfacing with a button panel to input selections related to the operation of the gaming device; and
displaying an inoperative replication of at least a portion of the button panel at the main display to provide visual feed back to the player related to said selections.

57. The method of claim 56 comprising displaying at said display an indicia representative of the position of the player's input at said interface.

58. The method of claim 56 comprising displaying an inoperative, semi-transparent of at least a portion of said interface over said content.

59. The method of claim 56 comprising the player interfacing with a touch screen display having at least one displayed input button.

60. The method of claim 59 comprising displaying an inoperative, semi-transparent of at least a portion of said interface over said content.

61. The method of claim 60 comprising displaying at said display an indicia representative of the position of the player's touch at said touch screen display.

62. The method of claim 56 comprising providing at least one of haptical and auditory feedback corresponding to said input.
